(19) United States
(12) Patent Application Publication
(10) Pub. No.: US 2025/0230299 A1
(43) Pub. Date: Jul. 17, 2025

(54) MOLDED BODY, COMPOSITE, TUBULAR FIXING MEMBER, FIXING DEVICE, AND IMAGE FORMING APPARATUS

(71) Applicant: FUJIFILM Business Innovation Corp., Tokyo (JP)

(72) Inventors: Ryohei YOSHIKAWA, Kanagawa (JP); Kenji Kajiwara, Kanagawa (JP); Taiki Nagamatsu, Kanagawa (JP); Tomotake Inagaki, Kanagawa (JP); Masayuki Seko, Kanagawa (JP)

(73) Assignee: FUJIFILM Business Innovation Corp., Tokyo (JP)

(21) Appl. No.: 18/807,375

(22) Filed: Aug. 16, 2024

(30) Foreign Application Priority Data
Jan. 17, 2024 (JP) 2024-005543

(51) Int. Cl. C08K 13/06; C08G 73/10; G03G 15/20

(52) U.S. Cl. CPC C08K 13/06; C08G 73/10; G03G 15/20

(57) ABSTRACT

A molded body includes: at least one polymer selected from the group consisting of resins and rubbers; and fillers dispersed in the polymer, in which the volume ratio of the fillers in the molded body is 25 vol % or less, and the average shortest distance between the fillers determined by three-dimensional analysis of the molded body with FIB-SEM is 30 nm or less.

### CROSS-REFERENCE TO RELATED APPLICATIONS

This application is based on and claims priority under 35 USC 119 from Japanese Patent Application No. 2024-005543 filed Jan. 17, 2024.

### BACKGROUND

### (i) Technical Field

The present disclosure relates to a molded body, a composite, a tubular fixing member, a fixing device, and an image forming apparatus.

### (ii) Related Art

Japanese Unexamined Patent Application Publication No. 2006-259712 discloses a seamless-type cylindrical heat fixing member having an elastic layer. The elastic layer contains carbon fibers and has a thermal conductivity of 1.0 W/m·K or more in the thickness direction.

Japanese Unexamined Patent Application Publication No. 2006-265315 discloses a composite material having a three-dimensional network carbon fiber structure composed of carbon fibers having outer diameters of 15 to 100 nm. The carbon fiber structure has particle parts from which multiple carbon fibers extend and that bind the carbon fibers to each other. The particle parts are formed during the growth of the carbon fibers. In the composite material, the carbon fiber structure is contained in a matrix in an amount of 0.1 to 30 mass % relative to the total amount of the composite material.

Japanese Unexamined Patent Application Publication No. 2012-122057 discloses an inorganic-organic composite composition including multiple thermoplastic resins constituting a matrix and a high thermal conductivity filler composed of an inorganic component that has higher thermal conductivity than the thermoplastic resins. One thermoplastic resin is a polyamide resin, and the other thermoplastic resin is a polyolefin resin. The high thermal conductivity filler is contained in the one thermoplastic resin more than in the other thermoplastic resin. The high thermal conductivity filler is in direct contact with itself to form a mesh structure.

Japanese Unexamined Patent Application Publication No. 2015-118327 discloses a resin base material including: a resin; a first filling agent having an aspect ratio of 2 or more and dispersed in the resin so as to orient in the in-plane direction of the base material; and a second filling agent having an aspect ratio of 2 or more, having a shorter major axis than the first filling agent, and dispersed in the resin so as to orient in the thickness direction of the base material.

Japanese Unexamined Patent Application Publication (Translation of PCT Application) No. 2023-516923 discloses a cured polymer composite including: a cured polymer containing a cured siloxane polymer or a cured silyl-terminated hybrid polymer; and at least one carbon nanostructure-derived material dispersed in the cured polymer and selected from the group consisting of carbon nanostructures, carbon nanostructure fragments, broken carbon nanotubes, stretched carbon nanostructure strands, and dispersed carbon nanostructures, and any combination thereof. The carbon nanostructures or the carbon nanostructure fragments include a plurality of multi-walled carbon nanotubes that are branched, interdigitated, entangled, and/or share a common layer with one another so that the multi-walled carbon nanotubes are cross-linked to one another in a polymeric structure. The broken carbon nanotubes are derived from the carbon nanostructures, are branched, and share a common layer with one another. The stretched carbon nanostructure strands are derived from the carbon nanostructures and include carbon nanotubes linearly aligned to one another. The dispersed carbon nanostructures include released broken carbon nanotubes that do not share a common layer with one another.

### SUMMARY

Aspects of non-limiting embodiments of the present disclosure relate to a molded body having better thermal conductivity than a molded body in which an average shortest distance between fillers determined by three-dimensional analysis of the molded body with FIB-SEM is more than 30 nm.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a molded body comprising: at least one polymer selected from the group consisting of resins and rubbers; and fillers dispersed in the polymer, wherein a volume ratio of the fillers in the molded body is 25 vol % or less, and an average shortest distance between the fillers determined by three-dimensional analysis of the molded body with FIB-SEM is 30 nm or less.

### BRIEF DESCRIPTION OF THE DRAWINGS

Exemplary embodiments of the present disclosure will be described in detail based on the following figures, wherein:

FIG. 1 is a schematic cross-sectional view of an example of a tubular fixing member according to an exemplary embodiment of the present disclosure;

FIG. 2 is a schematic structural view of an example of a fixing device according to a first exemplary embodiment of the present disclosure;

FIG. 3 is a schematic structural view of an example of a fixing device according to a second exemplary embodiment of the present disclosure; and

FIG. 4 is a schematic structural view of an example of an image forming apparatus according to an exemplary embodiment of the present disclosure.

### DETAILED DESCRIPTION

Exemplary embodiments of the present disclosure will be described below. The following description and Examples are for illustrating the exemplary embodiments, and are not intended to limit the scope of the exemplary embodiments.

The phase “A and/or B” in exemplary embodiments of the present disclosure has the same meaning as the phrase “at least one of A and B.” In other words, the phrase “A and/or B” means only A, only B, or a combination of A and B.

A numerical range expressed by using “to” in exemplary embodiments of the present disclosure indicates a range including the values before and after “to” as the minimum value and the maximum value.

With regard to numerical ranges described stepwise in exemplary embodiments of the present disclosure, the upper limit or the lower limit of one numerical range may be replaced by the upper limit or the lower limit of another stepwise described numerical range. The upper limit or lower limit of any numerical range described in exemplary embodiments of the present disclosure may be replaced by a value described in Examples.

In exemplary embodiments of the present disclosure, the term “step” includes not only an independent step but also a step that cannot be clearly distinguished from other steps but may accomplish the purpose of the step.

In the description of exemplary embodiments of the present disclosure with reference to the drawings, the structures according to the exemplary embodiments are not limited to the structures illustrated in the drawings. The sizes of members in each figure are schematic, and the relative relationship between the sizes of the members is not limited to what is illustrated.

In exemplary embodiments of the present disclosure, each component may include two or more corresponding substances. In exemplary embodiments of the present disclosure, the amount of each component in a composition refers to, when there are two or more substances corresponding to each component in the composition, the total amount of the substances present in the composition, unless otherwise specified.

In exemplary embodiments of the present disclosure, each component may include two or more types of particles corresponding to each component. The particle size of each component refers to, when there are two or more types of particles corresponding to each component in the composition, the particle size of a mixture of two or more types of particles present in the composition, unless otherwise specified.

In exemplary embodiments of the present disclosure, the “axial direction” of a tubular member means the direction in which the rotation shaft of the tubular member extends, and the “circumferential direction” of the tubular member means the rotation direction of the tubular member.

### Molded Body

A molded body according to an exemplary embodiment of the present disclosure contains at least one polymer selected from the group consisting of resins and rubbers, and fillers dispersed in the polymer.

In the molded body according to the exemplary embodiment of the present disclosure, the volume ratio of the fillers in the molded body is 25 vol % or less, and the average shortest distance between the fillers determined by three-dimensional analysis of the molded body with FIB-SEM is 30 nm or less.

The method of three-dimensional analysis of the molded body with focused ion beam scanning electron microscopes (FIB-SEM) and the method of determining the average shortest distance between the fillers will be described.

The molded body is cut into a rectangular prism with a width of 1 mm and embedded in an epoxy resin. The embedded material is subjected to cross-section processing with a microtome to form a block cross-section that shows the cross-section of the molded body in the thickness direction. A sample having the block cross-section is fixed to the sample stage in an FIB-SEM system (FIB-SEM Helios NanoLab 600i, FEI Company, USA) and subjected to vapor deposition. The FIB processing and SEM observation of the block cross-section are repeated in the FIB-SEM system to obtain two-dimensional stacking images. The FIB processing and SEM observation are repeated until at least 100 fillers are observed. The SEM observation is performed at a magnification that allows the fillers dispersed in the molded body to be observed.

The two-dimensional stacking images are imported into three-dimensional image analysis software (Avizo-Fire, VSG) to form a three-dimensional image.

At least 100 fillers are randomly selected from the formed three-dimensional image.

The closest filler is specified for each of the randomly selected fillers, and the shortest distance (nm) between the fillers is measured. If there is a filler in contact with a certain filler, the closest filler is the filler in contact with the certain filler, and the shortest distance between the fillers is 0 nm.

At least 100 measurements of the shortest distance are arithmetically averaged to obtain the average shortest distance (nm) between fillers.

The volume ratio of the fillers in the molded body is also determined by analyzing the formed three-dimensional image.

The molded body of the exemplary embodiment of the present disclosure has high thermal conductivity even if the volume ratio of the fillers is low (the volume ratio of the fillers is 25 vol % or less). The mechanism for this is assumed as described below.

The fact that the average shortest distance between the fillers is 30 nm or less means that the fillers are dispersed in the polymer such that they are close to each other and that the fillers close to each other form thermal conduction paths. Since heat is transferred through the thermal conduction paths, the molded body of the exemplary embodiment of the present disclosure has high thermal conductivity although the volume ratio of the fillers is 25 vol % or less.

To improve the thermal conductivity of the molded body of the exemplary embodiment of the present disclosure, the average shortest distance between the fillers is 30 nm or less, preferably 28 nm or less, more preferably 25 nm or less, still more preferably 22 nm or less. To improve the thermal conductivity of the molded body, the average shortest distance between the fillers is preferably as small as possible, and the average shortest distance between the fillers may be 0 nm.

To improve the flex resistance of the molded body of the exemplary embodiment of the present disclosure, the average shortest distance between the fillers is preferably 5 nm or more, more preferably 10 nm or more, still more preferably 15 nm or more.

To improve the flex resistance of the molded body, the volume ratio of the fillers in the molded body of the exemplary embodiment of the present disclosure is 25 vol % or less. From the viewpoint of the balance between the thermal conductivity and flex resistance of the molded body, the volume ratio of the fillers in the molded body is preferably 10 vol % or more and 25 vol % or less, more preferably 12 vol % or more and 20 vol % or less, still more preferably 14 vol % or more and 18 vol % or less.

### Polymer

The molded body according to the exemplary embodiment of the present disclosure contains at least one polymer selected from the group consisting of resins and rubbers. Polymers may be used singly or as a mixture of two or more.

Examples of resins include polyimide resin, polyamide resin, polyamide-imide resin, polyether ether ketone resin, thermotropic liquid crystal polymer, fluororesin, silicone resin, and polystyrene resin. Resins may be used singly or as a mixture of two or more. From the viewpoint of the heat resistance of the molded body, polyamide resin may be used as a resin.

Examples of rubbers include acrylic rubber, silicone rubber, fluorosilicone rubber, and fluororubber. Rubbers may be used singly or as a mixture of two or more. From the viewpoint of the heat resistance of the molded body, acrylic rubber or silicone rubber may be used as a rubber.

### Filler

The molded body of the exemplary embodiment of the present disclosure contains a filler. Fillers may be used singly or as a mixture of two or more.

From the viewpoint of thermal conductivity, filler materials may be, for example, carbon materials; silicon carbide; metal nitrides, such as aluminum nitride and boron nitride; metal oxides, such as aluminum oxide (alumina), boehmite (alumina monohydrate), silica, titania, zirconia, magnesium oxide, tin oxide, zinc oxide, and barium oxide.

Exemplary embodiments of the fillers include ceramic particles made of at least one material selected from the group consisting of aluminum nitride, boron nitride, and silicon carbide.

Exemplary embodiments of the fillers also include carbon fibers, such as carbon nanofibers and carbon nanotubes.

The fillers may be particles, fibrous, branched, plate-like, scale-like, flake-like, or in other shapes.

In some exemplary embodiments, the fillers include branched fillers. The branched fillers may be in the form of branched fibers.

The fillers in this form easily come close to each other to form thermal conduction paths, that is, the average shortest distance between the fillers tends to be 30 nm or less.

In some exemplary embodiments, the fillers include two or more types of fillers having different shapes.

Specific examples of two or more types of fillers having different shapes include a combination of a filler having a relatively large aspect ratio (e.g., a fibrous filler, a plate-like filler, a scale-like filler, or a flake-like filler) and a particle filler.

When the particle fillers are interspersed between the fillers having a relatively large aspect ratio, the fillers easily come close to each other to form thermal conduction paths, that is, the average shortest distance between the fillers tends to be 30 nm or less.

When the molded body contains a filler having a relatively large aspect ratio and a particle filler, the content ratio (former:latter) of two types of fillers is preferably 65:35 to 95:5, more preferably 70:30 to 90:10, still more preferably 75:25 to 85:15 on a volume basis.

In some exemplary embodiments, the fillers include two or more types of fillers having different surface properties.

Specific examples of two or more types of fillers having different surface properties include a combination of a filler having an acidic group on its surface and a filler having a basic group on its surface; and a combination of a positively charged filler and a negatively charged filler.

Two or more types of fillers having different surface properties come close to each other due to intermolecular forces, van der Waals forces, electrostatic attraction, ionic bonds, covalent bonds, or other forces, and as a result, the average shortest distance between the fillers tends to be 30 nm or less.

The filler surface properties can be imparted to the fillers by surface-treating the fillers with a coupling agent or a surfactant.

When the molded body contains two types of fillers having different surface properties, the content ratio of two types of fillers may be, for example, 35:65 to 65:35, 40:60 to 60:40, or 45:55 to 55:45 on a volume basis.

In some exemplary embodiments, the fillers include a first filler having a first functional group on its surface, and a second filler having, on its surface, a second functional group different from the first functional group. The first functional group and the second functional group are different in type.

The first filler and the second filler are connected to each other or come close to each other due to the attraction or reaction (e.g., intermolecular forces, van der Waals forces, electrostatic attraction, ionic bonds, covalent bonds) between the first functional group and the second functional group, and as a result, the average shortest distance between the fillers tends to be 30 nm or less.

Examples of a combination of the first functional group and the second functional group include a combination of an acidic group and a basic group, specifically, a combination of a carboxy group or a hydroxy group and an amino group.

Examples further include a combination of an isocyanate group and a hydroxyl group; and a combination of an epoxy group and an amino group.

A filler having a functional group on its surface can be produced by surface-treating a filler with a coupling agent having a functional group.

The type of functional group on the surface of the filler can be identified from the peak intensity of the functional group by infrared (IR) absorption spectroscopy.

The first filler having the first functional group on its surface and the second filler having the second functional group on its surface may have different shapes. Specific examples of two types of fillers having different shapes include a combination of a filler having a relatively large aspect ratio (e.g., a fibrous filler, a plate-like filler, a scale-like filler, or a flake-like filler) and a particle filler.

The content ratio of the first filler and the second filler in the molded body may be, for example, 35:65 to 65:35, 40:60 to 60:40, or 45:55 to 55:45 on a volume basis.

When the first filler and the second filler are a filler having a relatively large aspect ratio and a particle filler, respectively, the content ratio (former:latter) of two types of fillers is preferably 65:35 to 95:5, more preferably 70:30 to 90:10, still more preferably 75:25 to 85:15 on a volume basis.

The average major axis length of all the fillers in the molded body is preferably 1 μm or more and 40 μm or less, more preferably 2 μm or more and 30 μm or less, still more preferably 3 μm or more and 20 μm or less.

The average major axis length of all the fillers is determined by three-dimensional analysis of the molded body with FIB-SEM. At least 100 fillers are randomly selected from the formed three-dimensional image. The major axis length of each of the randomly selected fillers is measured, and the major axis lengths of at least 100 fillers are arithmetically averaged to obtain the average value.

### Properties of Molded Body

The thermal conductivity of the molded body of the exemplary embodiment of the present disclosure in the thickness direction is preferably 1.0 W/m·K or more, more preferably 1.5 W/m·K or more, still more preferably 2.0 W/m·K or more.

From the viewpoint of heat storage, the thermal conductivity of the molded body of the exemplary embodiment of the present disclosure in the thickness direction is preferably 5.0 W/m·K or less, more preferably 4.0 W/m. K or less, still more preferably 3.0 W/m·K or less.

The thermal conductivity (W/m·K) of the molded body of the exemplary embodiment of the present disclosure in the thickness direction is measured as describe below.

A sample subjected to measurement is a sample of 2 mm×2 mm×thickness direction and is taken from a central area of the largest surface of the molded body so as to keep the thickness of the molded body.

The thermal diffusivity in the thickness direction is measured at room temperature (25° C.±3° C.) using a thermal diffusivity measuring device, and the thermal diffusivity is multiplied by the specific heat and the density to calculate the thermal conductivity (W/m·K).

When the molded body of the exemplary embodiment of the present disclosure is a film, the molded body may be a flat film or a tubular film.

When the molded body of the exemplary embodiment of the present disclosure is a film, the average thickness of the molded body may be set according to the usage, and the average thickness is, for example, 10 μm or more and 1000 μm or less, 15 μm or more and 800 μm or less, or 20 μm or more and 500 μm or less.

When the molded body of the exemplary embodiment of the present disclosure is a film, the molded body is produced by, for example, a production method including step (1) to step (3) in order.

Step (1): Prepare a coating liquid by mixing a resin or a rubber and a filler. Add a solvent or a dispersion medium as needed.

Step (2): Apply the coating liquid onto a substrate and dry the coating liquid to form a coating film.

Step (3): Sinter the coating film to produce a molded body.

A tubular molded body can be produced by using a cylindrical die as the substrate in step (2).

Examples of the usage of the molded body of the exemplary embodiment of the present disclosure include sheets to be installed in electronic devices to absorb and release heat, and tubular fixing members in image forming apparatuses.

### Composite

A composite of an exemplary embodiment of the present disclosure includes the molded body of the exemplary embodiment of the present disclosure.

The composite of the exemplary embodiment of the present disclosure may be a composite made up of a plurality of the molded bodies of the exemplary embodiment of the present disclosure, or a composite made up of the molded body of the exemplary embodiment of the present disclosure and other objects.

When the composite of the exemplary embodiment of the present disclosure contains other objects other than the molded body of the exemplary embodiment of the present disclosure, the material and shape of other objects are not limited.

Examples of other objects contained in the composite of the exemplary embodiment of the present disclosure include an object made of a polymer material, an object made of a metal material, and an object made of a composite of a polymer material and a metal material.

The form and usage of the composite of the exemplary embodiment of the present disclosure are not limited. Examples of the usage of the composite of the exemplary embodiment of the present disclosure include thermal conductive sheets, heat dissipation sheets, furniture, building materials, machine parts, vehicle parts, and aircraft parts.

Exemplary embodiments of the composite of the present disclosure include a multilayer film including the molded body of the exemplary embodiment of the present disclosure molded in a film shape. The molded body of the exemplary embodiment of the present disclosure may be a flat film or a tubular film.

The multilayer film will be described below in detail.

### Multilayer Film

A multilayer film of an exemplary embodiment of the present disclosure includes the molded body of the exemplary embodiment of the present disclosure molded in a film shape.

The multilayer film of the exemplary embodiment of the present disclosure may be a multilayer film including only the molded bodies of the exemplary embodiment of the present disclosure stacked on top of each other, or a multilayer film including the molded body of the exemplary embodiment of the present disclosure and other films (e.g., a releasable film, a metal substrate, a ceramic film) stacked on top of each other. An adhesive layer may be disposed between the stacked films.

The multilayer film of the exemplary embodiment of the present disclosure may have one layer or two or more layers each composed of the molded body of the exemplary embodiment of the present disclosure molded in a film shape. When the multilayer film of the exemplary embodiment of the present disclosure has two or more layers each composed of the molded body of the exemplary embodiment of the present disclosure, these two or more layers each composed of the molded body may have the same or different components and/or compositions.

When the multilayer film of the exemplary embodiment of the present disclosure has two or more layers each composed of the molded body of the exemplary embodiment of the present disclosure molded in a film shape, the multilayer film may be, for example, a multilayer film including the molded body of the exemplary embodiment of the present disclosure where the fillers are dispersed in the resin, and the molded body of the exemplary embodiment of the present disclosure where the fillers are dispersed in the rubber, wherein the molded bodies are stacked on top of each other. The stacking order of these molded bodies is not limited.

The multilayer film of the exemplary embodiment of the present disclosure may be a flat film or a tubular film. Examples of the usage of the multilayer film of the exemplary embodiment of the present disclosure include sheets to be installed in electronic devices to absorb and release heat, and tubular fixing members in image forming apparatuses.

### Tubular Fixing Member

A tubular fixing member of an exemplary embodiment of the present disclosure includes the molded body of the exemplary embodiment of the present disclosure molded in a tubular shape.

The tubular fixing member of the exemplary embodiment of the present disclosure may be a member composed only of the molded body of the exemplary embodiment of the present disclosure, a member including the molded body of the exemplary embodiment of the present disclosure and other films stacked on top of each other, or a member including a plurality of the molded bodies of the exemplary embodiment of the present disclosure stacked on top of each other. When the tubular fixing member includes a plurality of the molded bodies of the exemplary embodiment of the present disclosure stacked on top of each other, the molded bodies may have the same or different components and/or compositions.

Exemplary embodiments of the tubular fixing member of the present disclosure include a tubular fixing member produced by stacking a substrate layer, an elastic layer, and a release layer in this order wherein one or both of the substrate layer and the elastic layer are the molded bodies of the exemplary embodiment of the present disclosure.

Examples of the above exemplary embodiment of the present disclosure include an embodiment in which the substrate layer is the molded body of the exemplary embodiment of the present disclosure where the fillers are dispersed in the resin and/or the elastic layer is the molded body of the exemplary embodiment of the present disclosure where the fillers are dispersed in the rubber.

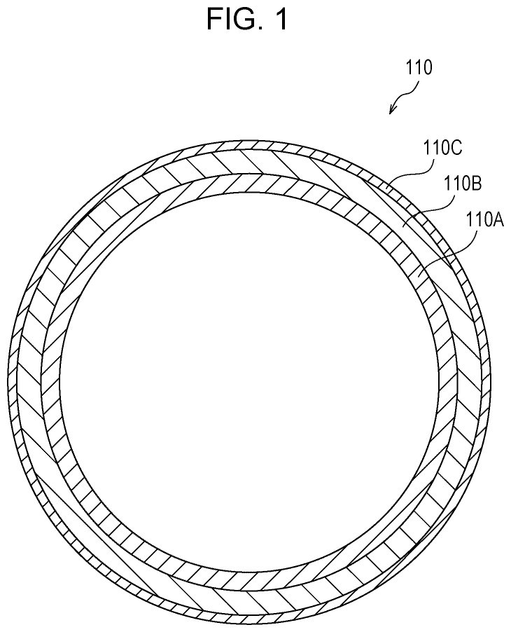

FIG. 1 is a schematic cross-sectional view of an example of the tubular fixing member according to the exemplary embodiment of the present disclosure.

Referring to FIG. 1, a tubular fixing member 110 includes a substrate layer 110A, an elastic layer 110B on the substrate layer 110A, and a release layer 110C on the elastic layer 110B. An adhesive layer may be disposed between the substrate layer 110A and the elastic layer 110B and/or between the elastic layer 110B and the release layer 110C. One or both of the substrate layer 110A and the elastic layer 110B are the molded bodies of the exemplary embodiment of the present disclosure. The substrate layer 110A may be the molded body of the exemplary embodiment of the present disclosure where the fillers are dispersed in the resin. The elastic layer 110B may be the molded body of the exemplary embodiment of the present disclosure where the fillers are dispersed in the rubber.

From the viewpoint of durability and thermal conductivity, the average thickness of the substrate layer 110A is preferably 20 μm or more and 200 μm or less, more preferably 30 μm or more and 150 μm or less, still more preferably 40 μm or more and 100 μm or less.

From the viewpoint of durability and thermal conductivity, the average thickness of the elastic layer 110B is preferably 30 μm or more and 500 μm or less, more preferably 50 μm or more and 480 μm or less, still more preferably 80 μm or more and 450 μm or less.

The release layer 110C may contain a release material having heat resistance. Examples of the release material having heat resistance include fluororesin. Examples of fluororesin include tetrafluoroethylene/perfluoroalkyl vinyl ether copolymer (PFA), polytetrafluoroethylene (PTFE), tetrafluoroethylene/hexafluoropropylene copolymer (FEP), polyethylene-tetrafluoroethylene (ETFE), polyvinylidene fluoride (PVDF), polychlorotrifluoroethylene (PCTFE), and vinyl fluoride (PVF).

The release layer 110C may contain various additives. Examples of additives include filling agents (e.g., calcium carbonate), functional filling agents (e.g., alumina), softeners (e.g., paraffin), processing aids (e.g., stearic acid), anti-aging agents (e.g., amines), and cross-linkers.

The average thickness of the release layer 110C is preferably 5 μm or more and 30 μm or less, more preferably 10 μm or more and 25 μm or less, still more preferably 15 μm or more and 20 μm or less.

The average thickness of each layer of the tubular fixing member is obtained by measuring, with an eddy current coating thickness meter, the film thickness of the tubular fixing member at 40 points in total, 10 points with regular intervals in the axial direction of the tubular fixing member and points with 90° intervals in the circumferential direction, and arithmetically averaging the film thicknesses.

Exemplary embodiments of the tubular fixing member of the present disclosure are not limited to the embodiment illustrated in FIG. 1. Exemplary embodiments of the tubular fixing member include an embodiment without the substrate layer 110A, an embodiment without the elastic layer 110B, and an embodiment with the release layer 110C.

The tubular fixing member of the exemplary embodiment of the present disclosure may have, for example, a cylindrical shape or a belt shape.

The tubular fixing member of the exemplary embodiment of the present disclosure may be a fixing belt or a fixing roller.

### Fixing Device

A fixing device of an exemplary embodiment of the present disclosure includes a first rotary body and a second rotary body in contact with the outer surface of the first rotary body and fixes a toner image to a recording medium with the toner image on its surface by passing the recording medium through a contact area between the first rotary body and the second rotary body. At least one of the first rotary body and the second rotary body is a rotary body that applies heat to a recording medium and is the tubular fixing member of the exemplary embodiment of the present disclosure.

Exemplary embodiments of the fixing device of the present disclosure include a first exemplary embodiment and a second exemplary embodiment.

A fixing device according to a first exemplary embodiment includes a heating roller and a pressure belt, and at least the heating roller is the tubular fixing member of the exemplary embodiment of the present disclosure.

A fixing device according to a second exemplary embodiment includes a heating belt and a pressure roller, and at least the heating belt is the tubular fixing member of the exemplary embodiment of the present disclosure.

### First Exemplary Embodiment

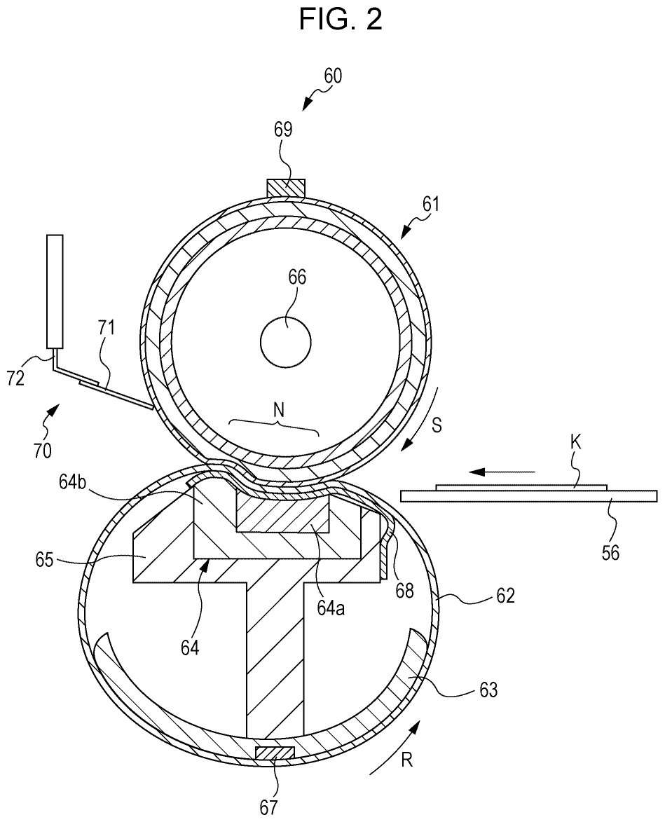

FIG. 2 is a schematic view of a fixing device 60 according to the first exemplary embodiment.

The fixing device 60 includes a heating roller 61 (exemplary first rotary body) and a pressure belt 62 (exemplary second rotary body).

A halogen lamp 66 (exemplary heating unit) is disposed inside the heating roller 61. A thermosensor 69 is disposed in contact with the surface of the heating roller 61. The lighting of the halogen lamp 66 is controlled on the basis of the temperature measured by the thermosensor 69 so that the surface temperature of the heating roller 61 is maintained at the intended set temperature (e.g., 150° C.).

The pressure belt 62 is rotatably supported by a pressure pad 64 and a belt running guide 63 disposed inside the pressure belt 62.

The pressure pad 64 presses the pressure belt 62 against the heating roller 61. The pressure belt 62 is pressed against the heating roller 61 by the pressure pad 64 to form a pinch region N (nip part).

The pressure pad 64 includes a pinch member 64a and a pinch member 64b. The pinch member 64a is disposed on the entrance side of the pinch region N to ensure the wide pinch region N. The pinch member 64b is disposed on the exit side of the pinch region N to distort the heating roller 61 and facilitate release of the recording medium.

A sliding member 68 having a sheet shape is disposed between the pressure pad 64 and the pressure belt 62 to reduce the sliding resistance between the inner circumferential surface of the pressure belt 62 and the pressure pad 64. The pressure pad 64 and the sliding member 68 are held by a holding member 65 made of metal. The belt running guide 63 is attached to the holding member 65. A lubricant supply device 67 is attached to the belt running guide 63. The lubricant supply device 67 is a unit that supplies a lubricant (oil) to the inner circumferential surface of the pressure belt 62.

A releasing member 70 is an auxiliary unit that releases the recording medium from the fixing device 60 and is disposed downstream of the pinch region N. The releasing member 70 includes a releasing claw 71 and a holding member 72. The releasing claw 71 is adjacent to the heating roller 61 and held by the holding member 72.

The heating roller 61 is rotationally driven by a drive motor (not shown). The heating roller 61 is rotated in the direction of an arrow S by the drive motor. The pressure belt 62 follows the rotation of the heating roller 61 and rotates in the direction of an arrow R. A sheet of paper K (exemplary recording medium) having an unfixed toner image is guided by a guide 56 and transported to the pinch region N. When the sheet of paper K passes through the pinch region N, the toner image on the sheet of paper K is fixed by pressure and heat.

### Second Exemplary Embodiment

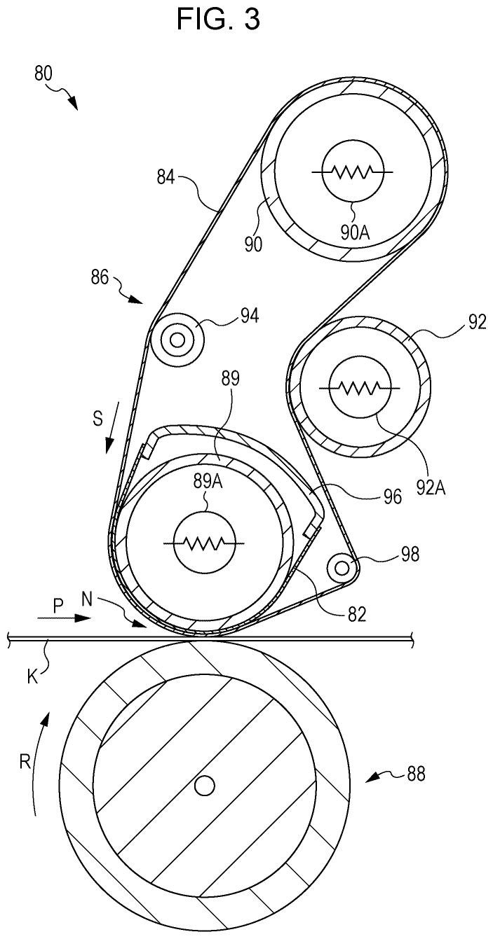

FIG. 3 is a schematic view of a fixing device 80 according to the second exemplary embodiment.

The fixing device 80 includes a fixing belt module 86 including a heating belt 84 (exemplary first rotary body) and a pressure roller 88 (exemplary second rotary body) pressed against the heating belt 84 (fixing belt module 86).

The pinch region N (nip part) is formed in a contact area between the heating belt 84 (fixing belt module 86) and the pressure roller 88.

The fixing belt module 86 includes the heating belt 84, a heating press roller 89, a support roller 90, a support roller 92, a posture correction roller 94, and a support roller 98. The heating belt 84 is wound around the heating press roller 89 and the support roller 90. The heating press roller 89 is rotationally driven by a drive motor (not shown) and presses the heating belt 84 from the inner circumferential surface of the heating belt 84 toward the pressure roller 88. The support roller 92 is disposed outside the heating belt 84 and defines the travel path of the heating belt 84. The posture correction roller 94 corrects the posture of the heating belt 84 from the support roller 90 to the heating press roller 89 to prevent or reduce meandering of the heating belt 84. The support roller 98 is disposed downstream of the pinch region N and applies tension to the heating belt 84 from the inner circumferential surface.

A sliding member 82 having a sheet shape is disposed between the heating belt 84 and the heating press roller 89 to reduce the sliding resistance between the inner circumferential surface of the heating belt 84 and the heating press roller 89. The sliding member 82 is disposed such that both ends of the sliding member 82 are supported by a support member 96.

A halogen heater 89A (exemplary heating unit) is disposed inside the heating press roller 89 and heats the heating belt 84 from the inner circumferential surface side.

A halogen heater 90A (exemplary heating unit) is disposed inside the support roller 90 and heats the heating belt 84 from the inner circumferential surface side.

A halogen heater 92A (exemplary heating unit) is disposed inside the support roller 92 and heats the heating belt 84 from the outer circumferential surface side.

The pressure roller 88 is rotatably supported and pressed against an area where the heating belt 84 is wound around the heating press roller 89 by an urging unit (not shown). The heating belt 84 rotationally moves in the direction of an arrow S upon rotationally driving the heating press roller 89, and the pressure roller 88 follows the rotational movement of the heating belt 84 and rotationally moves in the direction of an arrow R.

A sheet of paper K (exemplary recording medium) having an unfixed toner image is transported in the direction of an arrow P to reach the pinch region N in the fixing device 80. When the sheet of paper K passes through the pinch region N, the toner image on the sheet of paper K is fixed by pressure and heat.

### Image Forming Apparatus

An image forming apparatus of an exemplary embodiment of the present disclosure includes: an image carrier; a charging device that charges the surface of the image carrier; an electrostatic latent image forming device that forms an electrostatic charge image on the charged surface of the image carrier; a developing device that develops the electrostatic latent image on the surface of the image carrier by using a developer containing a toner to form a toner image; a transfer device that transfers the toner image to the surface of a recording medium; and the fixing device of the exemplary embodiment of the present disclosure, which fixes the toner image to the recording medium. The fixing device may be a process cartridge that is attachable to and detachable from the image forming apparatus.

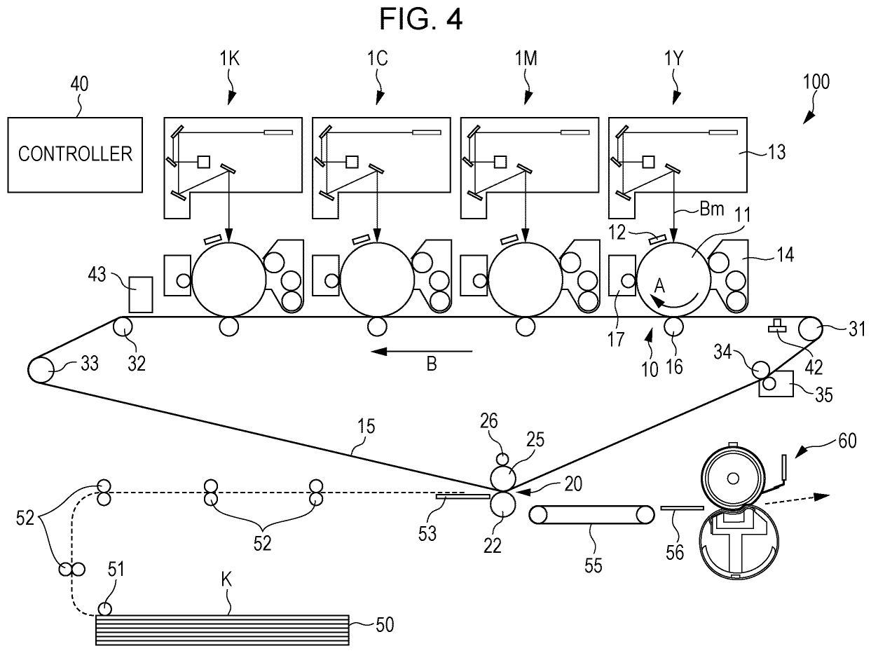

FIG. 4 is a schematic view of the structure of an image forming apparatus 100 according to an exemplary embodiment. The image forming apparatus 100 includes the fixing device 60 according to the first exemplary embodiment. The image forming apparatus 100 may include the fixing device 80 according to the second exemplary embodiment instead of the fixing device 60.

The image forming apparatus 100 is, what is called, a tandem-type intermediate-transfer image forming apparatus. The image forming apparatus 100 includes image forming units 1Y, 1M, 1C, and 1K that form toner images of the respective colors by using an electrophotographic system; first transfer sections 10 in which the toner images of the respective colors are sequentially transferred (first transferred) onto an intermediate transfer belt 15; a second transfer section 20 in which the superimposed toner images that have been transferred onto the intermediate transfer belt 15 are collectively transferred (second transferred) to a sheet of paper K used as a recording medium; the fixing device 60, which fixes the second transferred images to the sheet of paper K; and a controller 40 that controls the operation of each device (each section).

The image forming units 1Y, 1M, 1C, and 1K are substantially linearly arranged in the order of 1Y (yellow unit), 1M (magenta unit), 1C (cyan unit), and 1K (black unit) from the upstream side of the intermediate transfer belt 15.

The image forming units 1Y, 1M, 1C, and 1K each include a photoreceptor 11 (exemplary image carrier). The photoreceptor 11 rotates in the direction of an arrow A.

Each photoreceptor 11 is surrounded by a charger 12 (exemplary charging device), a laser exposure unit 13 (exemplary electrostatic latent image forming device), a developing unit 14 (exemplary developing device), a first transfer roller 16, and a photoreceptor cleaner 17 in this order in the rotation direction of the photoreceptor 11.

Each charger 12 charges the surface of the corresponding photoreceptor 11.

Each laser exposure unit 13 emits an exposure beam Bm to form an electrostatic latent image on the corresponding photoreceptor 11.

Each developing unit 14 contains a corresponding color toner and visualizes the electrostatic latent image on the corresponding photoreceptor 11 by using the toner.

Each first transfer roller 16 transfers the toner image on the corresponding photoreceptor 11 to the intermediate transfer belt 15 in a first transfer section 10.

Each photoreceptor cleaner 17 removes residual toner from the corresponding photoreceptor 11.

The intermediate transfer belt 15 is made of a material prepared by adding an antistatic agent, such as carbon black, to a resin, such as polyimide or polyamide. The intermediate transfer belt 15 has a volume resistivity of, for example, 1×10⁶ Ω·cm or more and 1×10¹⁴ Ω·cm or less and has a thickness of, for example, 0.1 mm.

The intermediate transfer belt 15 is supported by a drive roller 31, a support roller 32, a tension applying roller 33, a back side roller 25, and a cleaning back side roller 34. The intermediate transfer belt 15 is driven to circulate (rotate) in the direction of an arrow B as the drive roller 31 rotates.

The drive roller 31 is driven by a motor (not shown) with a constant speed to rotate the intermediate transfer belt 15.

The support roller 32, together with the drive roller 31, supports the intermediate transfer belt 15 extending substantially linearly in the direction in which the four photoreceptors 11 are arranged.

The tension applying roller 33 applies a constant tension to the intermediate transfer belt 15 and also functions as a correction roller that prevents or reduces meandering of the intermediate transfer belt 15.

The back side roller 25 is disposed in the second transfer section 20. The cleaning back side roller 34 is disposed in a cleaning section where residual toner is scraped off from the intermediate transfer belt 15.

The first transfer rollers 16 are arranged in pressure contact with the respective photoreceptors 11 with the intermediate transfer belt 15 therebetween to form the first transfer sections 10.

The first transfer rollers 16 receive a voltage (first transfer bias) with a polarity opposite to the charging polarity (negative polarity; the same applies hereinafter) of the toners. Thus, the toner images on the photoreceptors 11 are sequentially electrostatically attracted to the intermediate transfer belt 15, whereby the superimposed toner images are formed on the intermediate transfer belt 15.

Each first transfer roller 16 is a cylindrical roller including a shaft (e.g., a columnar rod made of a metal, such as iron or SUS) and an elastic layer (e.g., a sponge layer made of a blended rubber containing an electrically conductive agent, such as carbon black) attached to the surface of the shaft. Each first transfer roller 16 has a volume resistivity of, for example, 1×10^{7.5} Ω·cm or more and 1×10^{8.5} Ω·cm or less.

A second transfer roller 22 is disposed in pressure contact with the back side roller 25 with the intermediate transfer belt 15 therebetween to form the second transfer section 20.

The second transfer roller 22 forms a second transfer bias between the second transfer roller 22 and the back side roller 25 and second transfers the toner images onto a sheet of paper K (recording medium) transported to the second transfer section 20.

The second transfer roller 22 is a cylindrical roller including a shaft (e.g., a columnar rod made of a metal, such as iron or SUS) and an elastic layer (e.g., a sponge layer made of a blended rubber containing an electrically conductive agent, such as carbon black) attached to the surface of the shaft. The second transfer roller 22 has a volume resistivity of, for example, 1×10^{7.5} Ω·cm or more and 1×10^{8.5} Ω·cm or less.

The back side roller 25 is disposed on the back side of the intermediate transfer belt 15. The back side roller 25 serves as a counter electrode for the second transfer roller 22 and forms a transfer electric field between the back side roller 25 and the second transfer roller 22.

The back side roller 25 is formed by, for example, covering a rubber base material with a tube made of a blended rubber containing carbon dispersed therein. The back side roller 25 has a surface resistivity of, for example, 1×10⁷ Ω/□ or more and 1×10¹⁰ Ω/□ or less and a hardness of, for example, 70° (ASKER C available from Kobunshi Keiki Co., Ltd.; the same applies hereinafter).

The back side roller 25 is disposed in contact with a power supply roller 26 made of metal. The power supply roller 26 applies a voltage (second transfer bias) with the same polarity as the charging polarity (negative polarity) of the toners to form a transfer electric field between the second transfer roller 22 and the back side roller 25.

An intermediate transfer belt cleaner 35 is disposed at the intermediate transfer belt 15 downstream of the second transfer section 20 so as to freely move toward and away from the intermediate transfer belt 15. The intermediate transfer belt cleaner 35 removes residual toner and paper powder from the intermediate transfer belt 15 after second transfer.

A reference sensor (home position sensor) 42 is disposed upstream of the image forming unit 1Y. The reference sensor 42 generates a reference signal to be used as a reference for controlling the image forming timing in each image forming unit. The reference sensor 42 generates the reference signal in response to sensing a mark on the back side of the intermediate transfer belt 15. The image forming units 1Y, 1M, 1C, and 1K start image formation according to the instruction from the controller 40 that has sensed the reference signal.

An image density sensor 43 for image quality adjustment is disposed downstream of the image forming unit 1K.

The image forming apparatus 100 includes a paper storage unit 50, a paper feed roller 51, a transport roller 52, a transport guide 53, a transport belt 55, and a fixation entrance guide 56 as transport units that transport a sheet of paper K.

The paper storage unit 50 stores sheets of paper K before image formation.

The paper feed roller 51 ejects a sheet of paper K stored in the paper storage unit 50.

The transport roller 52 transports the sheet of paper K ejected by the paper feed roller 51.

The transport guide 53 delivers, to the second transfer section 20, the sheet of paper K transported by the transport roller 52.

The transport belt 55 transports, to the fixing device 60, the sheet of paper K to which an image has been transferred in the second transfer section 20.

The fixation entrance guide 56 guides the sheet of paper K to the fixing device 60.

Next, an image forming method using the image forming apparatus 100 will be described.

In the image forming apparatus 100, an image processor (not shown) performs image processing on image data outputted from an image reader (not shown), a computer (not shown), or other devices, and the image forming units 1Y, 1M, 1C, and 1K execute image formation.

The image processor performs image processing, such as shading correction, misregistration correction, lightness/color-space conversion, gamma correction, margin deletion, color editing, or moving and editing, on inputted reflectance data. The image data obtained by image processing is converted to color material gradation data for four colors, that is, Y, M, C, and K colors, and the color material gradation data is outputted to the laser exposure units 13.

The laser exposure units 13 radiate exposure beams Bm onto the respective photoreceptors 11 in the image forming units 1Y, 1M, 1C, and 1K according to the inputted color material gradation data.

The surfaces of the photoreceptors 11 in the image forming units 1Y, 1M, 1C, and 1K are charged by the chargers 12 and then scanned and exposed by the laser exposure units 13, whereby electrostatic latent images are formed on the respective photoreceptors 11. The electrostatic latent images formed on the respective photoreceptors 11 are developed into toner images of the respective colors by the image forming units.

The toner images formed on the respective photoreceptors 11 in the image forming units 1Y, 1M, 1C, and 1K are transferred onto the intermediate transfer belt 15 in the first transfer sections 10 where the photoreceptors 11 are in contact with the intermediate transfer belt 15. In the first transfer sections 10, the first transfer rollers 16 apply a voltage (first transfer bias) with a polarity opposite to the charging polarity (negative polarity) of the toners to the intermediate transfer belt 15, and the toner images are sequentially superimposed on top of one another and transferred onto the intermediate transfer belt 15.

The toner images that have been first transferred on the intermediate transfer belt 15 are transported to the second transfer section 20 as the intermediate transfer belt 15 moves.

At the same time as the toner images reach the second transfer section 20, a sheet of paper K stored in the paper storage unit 50 is transported by the paper feed roller 51, the transport roller 52, and the transport guide 53 to reach the second transfer section 20 and pinched between the intermediate transfer belt 15 and the second transfer roller 22.

The toner images on the intermediate transfer belt 15 are then electrostatically transferred (second transferred) onto the sheet of paper K in the second transfer section 20 where a transfer electric field is formed.

The sheet of paper K having the toner images electrostatically transferred thereon is released from the intermediate transfer belt 15 by the second transfer roller 22 and is transported to the fixing device 60 by the transport belt 55.

The sheet of paper K that has been transported to the fixing device 60 is heated and pressed by the fixing device 60 to fix the unfixed toner images to the sheet of paper K.

The image forming apparatus 100 forms an image on the recording medium through the foregoing process.

### EXAMPLES

Exemplary embodiments of the molded body will be described below in detail by way of Examples, but the exemplary embodiments of the molded body are not limited to these Examples.

In the following description, the units “part” and “%” are on a mass basis, unless otherwise specified.

In the following description, synthesis, production, treatment, measurement, and other steps are carried out at normal temperature (25° C.+3° C.), unless otherwise specified.

### Production of Molded Body

### Example 1

A coating liquid (1) is prepared by mixing a polyamic acid solution (TX-HMM, Unitika Ltd.) and branched carbon nanotubes (Cabot Corporation, ATHLOS CNS) and kneading the mixture with a three-roll mill. The polyamic acid solution and the branched carbon nanotubes are mixed such that the volume ratio of the branched carbon nanotubes when the polyamic acid solution is cured is as described in Table 1.

The coating liquid (1) is applied to the outer circumferential surface of a cylindrical die (diameter 30 mm) made of aluminum and dried at a temperature of 100° C. for 80 minutes. The coating amount of the coating liquid (1) is adjusted such that the molded body has a thickness of 80 μm. The cylindrical die having the coating film is placed in a heating furnace and heated at a temperature of 380° C. for 40 minutes to sinter the molded body. The cylindrical die under the molded body is removed to obtain a tubular molded body.

### Examples 2 to 3

A tubular molded body is produced in the same manner as in Example 1 except that the volume ratio of the filler is changed as described in Table 1.

### Comparative Examples 1 to 2

A tubular molded body is produced in the same manner as in Example 1 except that the filler is changed to unbranched carbon nanotubes (catalog value: fiber diameter 150 nm, fiber length 4 μm). The volume ratio of the filler is as described in Table 1.

### Example 4

A coating liquid (4) is prepared by mixing a liquid silicone rubber (two-component type, X-34-2826-A/B, Shin-Etsu Chemical Co., Ltd.) and branched carbon nanotubes (Cabot Corporation, ATHLOS CNS) and kneading the mixture with a three-roll mill. The liquid silicone rubber and the branched carbon nanotubes are mixed such that the volume ratio of the branched carbon nanotubes when the liquid silicone rubber is cured is as described in Table 1.

The coating liquid (4) is applied to the outer circumferential surface of a cylindrical die (diameter 30 mm) made of aluminum and dried at a temperature of 115° C. for 15 minutes. The coating amount of the coating liquid (4) is adjusted such that the molded body has a thickness of 400 μm. The cylindrical die having the coating film is placed in a heating furnace and heated at a temperature of 200° C. for 2 hours to sinter the molded body. The cylindrical die under the molded body is removed to obtain a tubular molded body.

### Comparative Example 3

A tubular molded body is produced in the same manner as in Example 4 except that the filler is changed to unbranched carbon nanotubes (catalog value: fiber diameter 150 nm, fiber length 4 μm).

### Example 5

A coating liquid (5) is prepared by mixing an acrylic rubber (Nipol AR51, Zeon Corporation) and branched carbon nanotubes (Cabot Corporation, ATHLOS CNS) and kneading the mixture with a three-roll mill. The acrylic rubber and the branched carbon nanotubes are mixed such that the volume ratio of the branched carbon nanotubes when the acrylic rubber is cured is as described in Table 1.

The coating liquid (5) is applied to the outer circumferential surface of a cylindrical die (diameter 30 mm) made of aluminum and dried at a temperature of 120° C. for 15 minutes. The coating amount of the coating liquid (5) is adjusted such that the molded body has a thickness of 400 μm. The cylindrical die having the coating film is placed in a heating furnace and heated at a temperature of 180° C. for 2 hours to sinter the molded body. The cylindrical die under the molded body is removed to obtain a tubular molded body.

### Comparative Example 4

A tubular molded body is produced in the same manner as in Example 5 except that the filler is changed to unbranched carbon nanotubes (catalog value: fiber diameter 150 nm, fiber length 4 μm).

### Example 6

A tubular molded body is produced in the same manner as in Example 1 except that the filler is changed to unbranched carbon nanotubes (catalog value: fiber diameter 150 nm, fiber length 4 μm) and spherical aluminum oxide particles (catalog value: particle size 25 μm). The amounts of the carbon nanotubes and the spherical aluminum oxide particles used are such that the volume ratio of the carbon nanotubes and the spherical aluminum oxide particles is as described in Table 1 when the polyamic acid solution is cured.

### Example 7

Unbranched carbon nanotubes (catalog value: fiber diameter 150 nm, fiber length 4 μm) having carboxy groups on their surfaces are prepared.

Spherical aluminum oxide particles (catalog value: particle size 25 μm) having amino groups on their surfaces are prepared.

Two types of fillers described above are mixed to obtain a filler mixture.

A tubular molded body is produced in the same manner as in Example 1 except that the filler is changed to the filler mixture. The amounts of the carbon nanotubes and the spherical aluminum oxide particles used are such that the volume ratio of the carbon nanotubes and the spherical aluminum oxide particles is as described in Table 1 when the polyamic acid solution is cured.

### Example 8

Spherical graphite particles (catalog value: particle size 15 μm) having hydroxy groups on their surfaces are prepared.

Boron nitride flakes (3M, CFP012) having amino groups on their surfaces are prepared.

Two types of fillers described above are mixed to obtain a filler mixture.

A tubular molded body is produced in the same manner as in Example 4 except that the filler is changed to the filler mixture. The amounts of the carbon nanotubes and the boron nitride flakes used are such that the volume ratio of the carbon nanotubes and the boron nitride flakes is as described in Table 1 when the liquid silicone rubber is cured.

### Analysis of Cross-Section of Molded Body

A rectangular prism that has three sides in the axial direction, the circumferential direction, and the film thickness direction and that is 1 mm in the circumferential direction and long in the axial direction is cut out from a central portion of a tubular molded body in the axial direction and embedded in an epoxy resin. The embedded material is subjected to cross-section processing with a microtome to form a block cross-section that shows the cross-section in the film thickness direction. A sample having the block cross-section is fixed to the sample stage in an FIB-SEM system (FIB-SEM Helios NanoLab 600i, FEI Company, USA) and subjected to vapor deposition. The FIB processing and SEM observation of the block cross-section are repeated in the FIB-SEM system to obtain two-dimensional stacking images. The FIB processing and SEM observation are repeated until at least 100 fillers are observed. The SEM observation is performed at a magnification that allows the fillers dispersed in the molded body to be observed.

The two-dimensional stacking images are imported into three-dimensional image analysis software (Avizo-Fire, VSG) to form a three-dimensional image.

At least 100 fillers are randomly selected from the formed three-dimensional image. The closest filler is specified for each of 100 fillers, and the shortest distance (nm) between the fillers is measured. One hundred measurements of the shortest distance are arithmetically averaged to obtain the average shortest distance (nm) between fillers. The results are shown in Table 1.

The volume ratio of the fillers in the molded body is also determined by analyzing the formed three-dimensional image. The results are shown in Table 1.

### Performance Evaluation of Molded Body

### Thermal Conductivity

A square of 2 mm in the axial direction×2 mm in the circumferential direction is taken from a central portion of the tubular molded body in the axial direction so as to keep the thickness of the molded body and used as a sample. The thermal diffusivity in the film thickness direction is measured at room temperature (25° C.±3° C.) using a thermal diffusivity measuring device ai-phase (ai-Phase Co., Ltd.), and the thermal diffusivity is multiplied by the specific heat and the density to calculate the thermal conductivity (W/m·K). The results are shown in Table 1.

### Flex Resistance

A rectangle of 150 mm in the axial direction×15 mm in the circumferential direction is taken from a central portion of the tubular molded body in the axial direction so as to keep the thickness of the molded body and used as a test piece. The number of double folds until the test piece breaks is obtained in accordance with the test for “flex resistance” described in JIS C5016:1994 using an MIT-type folding endurance tester MIT-DA (Toyo Seiki Seisaku-sho, Ltd). The arithmetic mean of 10 measurements is classified as described below. The results are shown in Table 1.
A: 10,000 or more
B: 5,000 or more and less than 10,000
C: 2,500 or more and less than 5,000
D: less than 2,500

The abbreviations in Table 1 have the following meanings.
PI: polyimide resin
Si rubber: silicone rubber
CNT: carbon nanotube
Alumina: aluminum oxide
BN: boron nitride

TABLE 1

| | | | | | | | | | Molded body | | |
|---|---|---|---|---|---|---|---|---|---|---|---|
| | | | | | | | | | Average | | |
| | | | | | | | | All | shortest | | |
| | | First filler | | | Second filler | | | fillers | distance | | Flex |
| | Polymer | | Functional | Volume | | Functional | Volume | Volume | between | Thermal | resistance |
| | Material | Material | group | ratio | Material | group | ratio | ratio | fillers | conductivity | classified |
| | type | type | type | % | type | type | % | % | nm | W/m · K | as |
| Example 1 | PI | branched | — | 15 | — | — | — | 15 | 28 | 1.4 | A |
| | | CNT | | | | | | | | | |
| Example 2 | PI | branched | — | 20 | — | — | — | 20 | 20 | 2.3 | B |
| | | CNT | | | | | | | | | |
| Example 3 | PI | branched | — | 22 | — | — | — | 22 | 14 | 2.9 | C |
| | | CNT | | | | | | | | | |
| Comparative | PI | CNT | — | 15 | — | — | — | 15 | 58 | 0.7 | A |
| Example 1 | | | | | | | | | | | |
| Comparative | PI | CNT | — | 22 | — | — | — | 22 | 47 | 0.9 | D |
| Example 2 | | | | | | | | | | | |
| Example 4 | Si | branched | — | 15 | — | — | — | 15 | 27 | 1.5 | A |
| | rubber | CNT | | | | | | | | | |
| Comparative | Si | CNT | — | 15 | — | — | — | 15 | 56 | 0.8 | A |
| Example 3 | rubber | | | | | | | | | | |
| Example 5 | acrylic | branched | — | 15 | — | — | — | 15 | 30 | 1.3 | A |
| | rubber | CNT | | | | | | | | | |
| Comparative | acrylic | CNT | — | 15 | — | — | — | 15 | 54 | 0.8 | A |
| Example 4 | rubber | | | | | | | | | | |
| Example 6 | PI | CNT | — | 12 | alumina | — | 3 | 15 | 26 | 1.8 | A |
| Example 7 | PI | CNT | carboxy | 12 | alumina | amino | 3 | 15 | 17 | 2.5 | A |
| | | | group | | | group | | | | | |
| Example 8 | Si | graphite | hydroxy | 12 | BN | amino | 3 | 15 | 19 | 2.4 | A |
| | rubber | | group | | | group | | | | | |

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) A molded body comprising:
at least one polymer selected from the group consisting of resins and rubbers; and
fillers dispersed in the polymer,
wherein a volume ratio of the fillers in the molded body is 25 vol % or less, and
an average shortest distance between the fillers determined by three-dimensional analysis of the molded body with FIB-SEM is 30 nm or less.
   (((2))) The molded body according to (((1))), wherein the volume ratio of the fillers in the molded body is 10 vol % or more and 20 vol % or less.
   (((3))) The molded body according to (((1))) or (((2))), wherein the fillers include branched fillers.
   (((4))) The molded body according to any one of (((1))) to (((3))), wherein the fillers include two or more types of fillers having different shapes, or two or more types of fillers having different surface properties.
   (((5))) The molded body according to any one of (((1))) to (((4))), wherein the fillers include a first filler having a first functional group on a surface of the first filler, and a second filler having, on a surface of the second filler, a second functional group different from the first functional group.
   (((6))) The molded body according to (((5))), wherein the first functional group is a carboxy group or a hydroxy group, and the second functional group is an amino group.
   (((7))) The molded body according to any one of (((1))) to (((6))), wherein the polymer includes at least one selected from the group consisting of polyimide resin, acrylic rubber, and silicone rubber.
   (((8))) A composite including the molded body according to any one of (((1))) to (((7))).
   (((9))) A tubular fixing member including the molded body according to any one of (((1))) to (((7))) molded in a tubular shape.
   (((10))) A fixing device comprising:
a first rotary body; and
a second rotary body in contact with an outer surface of the first rotary body,
wherein at least one of the first rotary body and the second rotary body is the tubular fixing member according to (((9))), and
the fixing device fixes a toner image to a recording medium with the toner image on a surface of the recording medium by passing the recording medium through a contact area between the first rotary body and the second rotary body.
   (((11))) An image forming apparatus comprising:
an image carrier;
a charging device that charges a surface of the image carrier;
an electrostatic latent image forming device that forms an electrostatic latent image on the charged surface of the image carrier;
a developing device that develops the electrostatic latent image on the surface of the image carrier by using a developer containing a toner to form a toner image;
a transfer device that transfers the toner image to a surface of a recording medium; and
the fixing device according to (((10))) that fixes the toner image to the recording medium.

What is claimed is:

1. A molded body comprising:
at least one polymer selected from the group consisting of resins and rubbers; and
fillers dispersed in the polymer,
wherein a volume ratio of the fillers in the molded body is 25 vol % or less, and
an average shortest distance between the fillers determined by three-dimensional analysis of the molded body with FIB-SEM is 30 nm or less.

2. The molded body according to claim 1, wherein the volume ratio of the fillers in the molded body is 10 vol % or more and 20 vol % or less.

3. The molded body according to claim 1, wherein the fillers include branched fillers.

4. The molded body according to claim 1, wherein the fillers include two or more types of fillers having different shapes, or two or more types of fillers having different surface properties.

5. The molded body according to claim 1, wherein the fillers include a first filler having a first functional group on a surface of the first filler, and a second filler having, on a surface of the second filler, a second functional group different from the first functional group.

6. The molded body according to claim 5, wherein the first functional group is a carboxy group or a hydroxy group, and the second functional group is an amino group.

7. The molded body according to claim 1, wherein the polymer includes at least one selected from the group consisting of polyimide resin, acrylic rubber, and silicone rubber.

8. A composite comprising the molded body according to claim 1.

9. A composite comprising the molded body according to claim 2.

10. A composite comprising the molded body according to claim 3.

11. A composite comprising the molded body according to claim 4.

12. A composite comprising the molded body according to claim 5.

13. A composite comprising the molded body according to claim 6.

14. A composite comprising the molded body according to claim 7.

15. A tubular fixing member comprising the molded body according to claim 1 molded in a tubular shape.

16. A tubular fixing member comprising the molded body according to claim 2 molded in a tubular shape.

17. A tubular fixing member comprising the molded body according to claim 3 molded in a tubular shape.

18. A tubular fixing member comprising the molded body according to claim 4 molded in a tubular shape.

19. A fixing device comprising:
a first rotary body; and
a second rotary body in contact with an outer surface of the first rotary body,
wherein at least one of the first rotary body and the second rotary body is the tubular fixing member according to claim 15, and
the fixing device fixes a toner image to a recording medium with the toner image on a surface of the recording medium by passing the recording medium through a contact area between the first rotary body and the second rotary body.

20. An image forming apparatus comprising:
an image carrier;
a charging device that charges a surface of the image carrier;
an electrostatic latent image forming device that forms an electrostatic latent image on the charged surface of the image carrier;
a developing device that develops the electrostatic latent image on the surface of the image carrier by using a developer containing a toner to form a toner image;
a transfer device that transfers the toner image to a surface of a recording medium; and
the fixing device according to claim 19 that fixes the toner image to the recording medium.
